(19) United States
(12) Patent Application Publication
(10) Pub. No.: US 2018/0253779 A1
(43) Pub. Date: Sep. 6, 2018

(54) SYSTEM AND METHOD FOR DYNAMICALLY PROVIDING RECOMMENDATIONS TO ONE OR MORE VENDORS

(71) Applicant: WIPRO Limited, Bangalore (IN)

(72) Inventor: Deepak DONGRE, Bangalore (IN)

(21) Appl. No.: 15/464,038

(22) Filed: Mar. 20, 2017

(30) Foreign Application Priority Data
Mar. 6, 2017 (IN) 201741007783

(51) Int. Cl. G06Q 30/06; H04L 29/08; G06Q 10/08; G06N 99/00

(52) U.S. Cl. CPC G06Q 30/0631; H04L 67/18; H04L 67/12; G06N 99/005; G06Q 10/087

(57) ABSTRACT

This disclosure relates generally to electronic commerce and more particularly to a system and method for dynamically providing recommendations to one or more vendors.

In one embodiment, a system for dynamically providing recommendations

to one or more vendors, is disclosed, comprising a processor and a memory communicatively coupled to the processor. The memory stores processor instructions, which, on execution, causes the processor to receive at least one of an area map, vendor location data associated with the one or more vendors, customer location data associated with one or more potential customers and an inventory of products. The processor further dynamically provides the recommendations to the one or more vendors, wherein the recommendations comprises at least one of pricing of the products for each of the one or more potential customers.

### PRIORITY CLAIM

This U.S. patent application claims priority under 35 U.S.C. § 119 to: Indian Application No. 201741007783, filed Mar. 6, 2017. The aforementioned applications are incorporated herein by reference in their entirety.

### TECHNICAL FIELD

This disclosure relates generally to electronic commerce and more particularly to a system and method for dynamically providing recommendations to one or more vendors.

### BACKGROUND

Street vendors may sell fresh vegetables, prepared food, beverages, household items, tools, clothing, building materials, crafts, consumer electronics, auto-repairs and so on. Since the street vendors provide easy access to wide ranges of products in open space, the street vendors are considered to be an integral part of urban economies. Poor customers may get access to otherwise unaffordable products. Street vending may also act as an attraction to foreign tourists searching for an authentic experience. The street vendors may also generate revenue to government through payment for licenses and permits, and payment of fees, fines and applicable taxes.

Street vendors may be associated with temporary static structure or mobile stalls. The street vendors, with mobile stalls may move from one location to another. Traditionally, the street vendors with mobile stalls, may inform potential customers of their presence, through loud street cries or chants. Also, traditionally, prior experience, common sense, advise from public and intuition may be used to select the particular location, the particular time, the particular product mix, that may maximize profit and minimize costs.

### SUMMARY

In an embodiment, the present disclosure illustrates a method of dynamically providing recommendations to one or more vendors. The method comprising receiving at least one of an area map, vendor location data associated with the one or more vendors, customer location data associated with one or more potential customers and an inventory of products. The method further comprising dynamically providing the recommendations to the one or more vendors, wherein the recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time, wherein the recommendations comprises at least one of pricing of the products for each of the one or more potential customers.

In another embodiment, the present disclosure illustrates a system for dynamically providing recommendations to one or more vendors. The system comprises a processor and a memory communicatively coupled to the processor. The memory stores processor instructions, which, on execution, causes the processor to receive at least one of an area map, vendor location data associated with the one or more vendors, customer location data associated with one or more potential customers and an inventory of products. The processor further dynamically provides the recommendations to the one or more vendors, wherein the recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time, wherein the recommendations comprises at least one of pricing of the products for each of the one or more potential customers.

In an embodiment, the present disclosure relates to a non-transitory computer readable medium including instructions stored thereon that when processed by at least one processor may cause a system to receive at least one of an area map, vendor location data associated with the one or more vendors, customer location data associated with one or more potential customers and an inventory of products. The instructions cause the processor to dynamically provides the recommendations to the one or more vendors. The recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time. The recommendations comprises at least one of pricing of the products for each of the one or more potential customers.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation comprising a processing circuit for dynamically providing recommendations to one or more vendors, according to some embodiments of the present disclosure.

FIG. 2 is a flow diagram illustrating a method of dynamically providing recommendations to one or more vendors in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present subject matter discloses a system and method for dynamically providing recommendations to one or more vendors. The system and method may be implemented in a variety of computing systems.

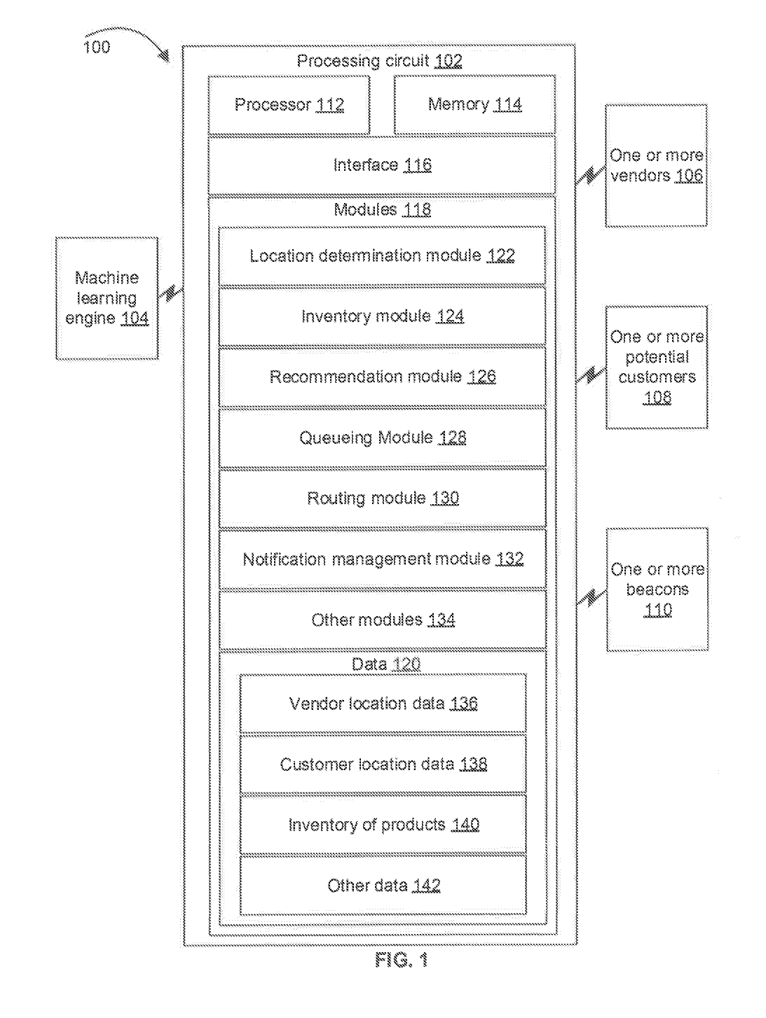

Working of the systems and methods for dynamically providing recommendations to the one or more vendors is described in conjunction with FIG. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network environment 100 comprising a processing circuit 102, in accordance with some embodiments of the present disclosure. As shown in FIG. 1, the processing circuit 102 is communicatively coupled to a machine learning engine 104, one or more vendors 106, one or more potential customers 108 and one or more beacons 110. Although the machine learning engine 104 is shown external to the processing circuit 102 in FIG. 1, it may be noted that, in one implementation, the machine learning engine 104 may be present within the processing circuit 102.

The processing circuit 102 may be communicatively coupled to the machine learning engine 104, the one or more vendors 106, the one or more potential customers 108 and the one or more beacons 110 through a network. The network may be a wireless network. The network can be implemented as one of the different types of networks, such as intranet, wireless local area network (LAN), wireless wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network may include a variety of network devices, including routers, bridges, servers, computing devices, storage devices, etc.

As shown in FIG. 1, the processing circuit 102 comprises a processor 112, a memory 114 coupled to the processor 112, and interface(s) 116. The processor 112 may be implemented as one or more microprocessors, microcomputers, microcontrollers, digital signal processors, central processing units, state machines, logic circuitries, and/or any devices that manipulate signals based on operational instructions. Among other capabilities, the processor 112 is configured to fetch and execute computer-readable instructions stored in the memory 114. The memory 114 can include any non-transitory computer-readable medium known in the art including, for example, volatile memory (e.g., RAM), and/or non-volatile memory (e.g., EPROM, flash memory, etc.).

The interface(s) 116 may include a variety of software and hardware interfaces, for example, a web interface etc., allowing the processing circuit 102 to interact with user devices. Further, the interface(s) 116 may enable the processing circuit 102 respectively to communicate with other computing devices. The interface(s) 116 can facilitate multiple communications within a wide variety of networks and protocol types, including wireless networks such as WLAN, cellular, or satellite. The interface(s) 116 may include one or more ports for connecting a number of devices to each other or to another server.

In one example, the processing circuit 102 includes modules 118 and data 120. In one embodiment, the modules 118 and the data 120 may be stored within the memory 114. In one example, the modules 118, among other things, include routines, programs, objects, components, and data structures, which perform particular tasks or implement particular abstract datatypes.

In one implementation, the modules 118 include a location determination module 122, an inventory module 124, a recommendation module 126, a queueing module 128, a routing module 130 and a notification management module 132. In an example, the modules may also comprise other modules 134. The other modules 134 may perform various miscellaneous functionalities of the processing circuit 102. It will be appreciated that such aforementioned modules may be represented as a single module or a combination of different modules.

In one example, the data 120 serves, among other things, as a repository for storing data fetched, processed, received and generated by one or more of the modules 118. In one implementation, the data 120 may include vendor location data 136, customer location data 138 and an inventory of products 140. In one embodiment, the data 120 may be stored in the memory 114 in the form of various data structures. In an example, the data 120 may also comprise other data 142 including temporary data and temporary files, generated by the modules 118 for performing the various functions of the processing circuit 102.

In order to dynamically provide recommendations to the one or more vendors 106, the processing circuit 102 may receive at least one of the area map, the vendor location data 136, the customer location data 138 and the inventory of products 140. The location determination module 122 may be used to determine the area map, the vendor location data 136 and the customer location data 138. In one implementation, the vendor location data 136 and the customer location data 138 may be determined using Global Positioning System (GPS). The vendor location data 136 may be present location of the one or more vendors 106. The customer location data 138 may be present location of the one or more potential customers 108. The area map may be built using satellite imagery, data provided by mobile phones of the one or more vendors 106 and data provided by the mobile phones of the one or more potential customers 108. In one embodiment, the area map may comprise vertical divisions of area and horizontal divisions of area. In one illustration, the horizontal divisions of area may be H1, H2, and so on. In the same illustration, H1 may be an apartment complex with several floors. H1 may comprise the vertical divisions of area such as V11, V12 and so on. In another embodiment, the area map may further comprise a pictorial view of the expected waiting period of the one or more vendors 106. In one embodiment, the expected waiting period may be determined using number of the potential customers 108 in the particular area (the particular area may be an area where a vendor 106 is attempting to make a sale), demand of the potential customers 108 for a product mix and purchasing history of the potential customers 108. In another embodiment, the area map may indicate a pictorial representation of previous sale of products in different time ranges.

The inventory of products 140 may be received from the inventory module 124. In one embodiment, the inventory module 124 may utilize economic order quantity (EOQ) to determine the quantity of products that may be included in the inventory, by minimizing holding costs and ordering costs. The inventory of products 140 may be determined based on total demand for the products for the year, purchase costs for each product, fixed cost to place the order and the storage cost for each product per year. The inventory module 124 may also decide on the product mix for each vendor 106. An illustration for product mix for vendor 1 may be mobile phones, fancy key chains, toys and so on, and product mix for vendor 2 may be vegetables and fruits. In one illustration, the product mix for the particular area for a specific day may be based on purchasing history of each potential customer 108 in the particular area for the specific day, shelf life of the products, demand for the products and season. Season may comprise an indication of change in weather, an indication of the festival season and so on. For instance, the Christmas season may be a time for attempting to sell decoration items, especially in posh areas of the society. In another instance, there may be a higher chance of selling products, that are nearing the end of its shelf life, in rural areas. When the vendors are unable to sell the products, the remaining products may be added to the inventory. The vendors may give inventory updates via their mobile phones.

After receiving at least one of the area map, the vendor location data 136, the customer location data 138 and the inventory of products 140, recommendations may be dynamically provided to the one or more vendors 106, by the recommendation module 126. The recommendations may comprise a recommendation for pricing of the products for each potential customer 108. The recommendations may further comprise, recommended location that may be indicated in the area map, number of vendors 106 assigned to the particular area for the specific time, quantity of the products for the particular area, product mix for the particular area, expected profit margins from the products and expected waiting period of the vendors 106. The recommended location may be the same as the particular area, when the vendor 106 accepts the recommendation of the processing circuit 102. For instance, when the recommended location is location A and the vendor 106 decides to go to location A. The recommended location may be different from the particular area, when the vendor 106 rejects the recommendation of the processing circuit 102.

In one embodiment, the recommendations to the vendors 106 may be based on the vendor location data 136, the customer location data 138, the inventory of products 140, the expected waiting period of the vendors 106 in the particular area, the purchasing history of each potential customers 108 in the particular area, shelf life of the products, travel costs, demand for the products in the particular area, and season.

In one illustration, the pricing of the products may be recommended to the vendors 106. Initial pricing of the products may be determined from costs for procuring the products, travel costs, vendor salary, profit margin and customer discount. The travel costs may comprise vehicle costs, vehicle maintenance costs and fuel costs. In one illustration, the vehicle may be a cart. The profit margin may be determined from the costs for procuring the products, demand for the products in the particular area for the particular time and perishable product factor. In one illustration, the perishable product factor may be determined using time-temperature indicator. In one illustration, the profit margin may be determined using the following equation:

PM=αC+βP_{d}−μ−λD
Where,
C—Cost of the product
P_{d}— Product demand in the particular area
D—Customer discount
μ—Perishable product factor
μ∞1/Dₚ, wherein Dₚ is a representation of the number of days for the product to perish.

In one illustration, an image of the products may be taken and fed to the processing circuit 102. Using Image Processing Techniques, the Dₚ factor may be determined, which may enable the recommendation module 126 to recommend a profit margin for the recommended location and the particular time.

After recommending initial pricing, the pricing of the products may be updated based on the vendor location data 136, the customer location data 138, the inventory of products 140, the expected waiting period of the vendors 106 in the particular area, the purchasing history of each potential customers 108 in the particular area, the shelf life of the products, the travel costs, the demand for the products in the particular area, and the season. In one illustration, the pricing may be increased in situations where the vendor location data 136 or customer location data 138 indicates a posh area. In one illustration, the pricing of the products may also be increased if the products availability in the inventory is low. In other words, the price may be increased when the product is a rare item. In another illustration, the pricing of the products may be decreased if the expected waiting period for the vendors 106 is high. In another illustration, the pricing of the products may be decreased if the purchasing history of the potential consumers 108 show a reluctance to pay high prices. Pricing of the product may be lesser when the product is closer to the end of its shelf life, in one illustration. If the travel costs are higher, the vendors 106 may ask for a higher price, in one illustration. If the demand for a particular product is high, then the vendors 106 may ask for a higher price for that particular product, in another illustration. In another illustration, the prices may be higher for the products that are invariably purchased during festive seasons such as Christmas trees during Christmas season. The list of the recommendations is not an exhaustive list. In one illustration, the demand for the products in area 1 may be reduced substantially because the process of sale may have become monotonous in area 1. A recommendation to the vendor 106 in area 1 may be to change the look and feel of the cart, to attract customers 108. The recommendations may be improved using a machine learning engine 104. For instance, if a change in the look and feel of the cart in area 2 did not lead to an increase in demand then a different vendor 106 may be routed to area 2.

In one illustration, the initial pricing of the products may be determined using the following equations:

P=C+Cₘ+S_{y}+PM−D (1)
Where,
P—Initial pricing of the product.
C—Procuring costs
Cₘ—Travel costs per day
S_{y}— Vendor salary per day
PM—Profit margin
D—Customer discount

The initial pricing may be updated, using the machine learning engine 104, based on the equation, P=XC+YCₘ+ZS_{y}+Ω PM, where the X, Y, Z and Ω are factors that are based on the vendor location data 136, the customer location data 138, the inventory of products 140, the expected waiting period of the vendors 106 in the particular area, the purchasing history of each potential customers 108 in the particular area, the shelf life of the products, the travel costs, the demand for the products in the particular area, and the season. These factors may be stored in a database, and these may be used to improve the accuracy of the processing circuit 102. In one illustration, X, Y, Z and Ω factors in Christmas season of 2007 may be found to be similar to the X, Y, Z and Ω factors in Christmas season of 2006 for the same area. Then the X, Y, Z and Ω factors may be saved according to the time interval for the area and it may be reused for the same time interval in the same area for the next year. When the system matures, the linear equation (1) may be evolved to quadratic form, parabolic form or cubic form.

The recommendations to the vendors 106 may also comprise a recommendation of the number of vendors 106 to be assigned to the particular area for the particular time. An illustration for the particular time may be Sunday morning. In one embodiment, the number of vendors 106 that needs to be assigned to the particular area for the particular time may be determined, by the queueing module, using the queueing theory. In one illustration, λ may be arrival rate of the potential customers 108 and μ may be service rate of the vendors 106. Traffic intensity in the illustration may be ρ=Alp. The length of the system (or the particular area) may be determined using the equation Lₛ=ρ/(1−ρ). From the length of the particular area, the average waiting time of the potential customers 108 in the particular area may be determined using the equation, Wₛ=Lₛ/λ. The number of vendors 106 that can efficiently manage the potential customers 108 in the particular area may be calculated using the Wₛ. For instance, on Sundays, the average waiting period of the potential customers 108 may be 30 minutes when only one vendor 106 with a service rate of 5, is managing the customers 108. 6 more vendors 106 with the same service rate of 5 may be able to handle the demand of the customers 108 better.

The recommendation module 126 may also recommend the quantity of the products for the particular area for the specific day. The quantity of products may be determined by modelling transportation problem. The objective of modelling transportation problem may be to determine the quantity of products that needs to be transported to each recommended location by keeping the costs at a minimum. In one illustration, Linear Programming (LP) may be utilized.

TABLE 1

| Origin | Area 1 (A1) | Area 2 (A2) | Area 3 (A3) | Supply |
|---|---|---|---|---|
| Warehouse1 (Wh1) | 5 | 6 | 4 | 300 |
| Warehouse2 (Wh2) | 6 | 3 | 7 | 500 |
| Demand | 200 | 300 | 250 | |

Table 1. indicates the transportation problem. Wh1 and Wh2 are the sources of the products. A1, A2, A3 are the recommended locations for two vendors. The supply for Wh1 is 300 and the supply for Wh2 is 500. The total supply for both the ware houses is 800. The demand for the products in A1, A2 and A3 is 200, 300, 250 respectively. The shipping costs from Wh1, for each unit of the product, in A1, A2, A3, is 5, 6, 4 respectively. Similarly, the shipping costs from Wh2, for each unit of the product, in A1, A2, A3 is 6, 3, 7 respectively.

Q_{(Wh1)(A1)}, Q_{(Wh1)(A2)}, Q_{(Wh1)(A3)} is a representation of the quantity of products shipped from Wh1 to A1, A2, A3 respectively. Similarly, Q_{(Wh2)(A1)}, Q_{(Wh2)(A2)}, Q_{(Wh2)(A3)} is a representation of the quantity of products shipped from Wh2 to A1, A2, A3 respectively.

The quantity of the products for the recommended locations for the particular time may be determined using the following equations:

Min(5Q_{(Wh1)(A1)}+6Q_{(Wh1)(A2)}+4Q_{(Wh1)(A3)}+6Q_{(Wh2)(A1)}+3Q_{(Wh2)(A2)}+7Q_{(Wh2)(A3)}) (i)

Q_{(Wh1)(A1)}+Q_{(Wh1)(A2)}+Q_{(Wh1)(A3)}<=300 (ii)

Q_{(Wh2)(A1)}+Q_{(Wh2)(A2)}+Q_{(Wh2)(A3)}<=500 (iii)

Q_{(Wh1)(A1)}+Q_{(Wh2)(A1)}=200 (iv)

Q_{(Wh1)(A2)}+Q_{(Wh2)(A2)}=300 (v)

Q_{(Wh1)(A3)}+Q_{(Wh2)(A3)}=250 (vi)

Q_{(Wh1)(A1)},Q_{(Wh1)(A2)},Q_{(Wh1)(A3)},Q_{(Wh2)(A1)},Q_{(Wh2)(A2)},Q_{(Wh2)(A3)}>=0 (vi)

Equation (i) indicates the objective of the transportation problem, that is the transportation of the products to the recommended locations while minimizing the costs. The sum of the quantities of products from Wh1 cannot exceed the total supply limit of the Wh1, that is 300, as indicated by equation (ii). The sum of the quantities of products from Wh2 cannot exceed the total supply limit of the Wh2, that is 500, as indicated by equation (iii). Since the total supply of the products from both the warehouses is more than the total demand of the products from the three areas, the supply may be able to fully satisfy the demand. Hence, sum of the quantities of the product transported to A1, may be equal to the demand of the product in A1, as indicated in equation (iv). Sum of the quantities of the product transported to A2, may be equal to the demand of the product in A2, as indicated in equation (v). Sum of the quantities of the product transported to A3, may be equal to the demand of the product in A3, as indicated in equation (vi). The quantities of the products are positive numbers as indicated by equation (vii).

Modelling of the transportation problem may have to be done frequently. This is because the demand of the potential customers 108 for the products may vary on a daily basis. In one illustration, the transportation may have to be modelled on a daily basis.

The recommendation to the vendors 106 are not enforced upon the vendors 106. For instance, the processing circuit 102 may suggest a pricing of 3$ for a product. The vendor 106 may choose to ask for 5$. The processing circuit 102 may display to the vendor, the loss that the vendor may have to incur if the vendor 106 attempts to sell the product for 5$.

In addition to dynamically providing recommendations to the vendors 106, the routing module 130 may also dynamically determine routing options in the area map. The end objective of routing is to minimize costs and maximize profit. The area map may consist of all the recommended locations along with an improvised routing showing the order in which these recommended locations needs to be approached, by the vendors 106. In one illustration, location A, location B and location C are the recommended locations. Even though the location A is nearer to the vendor 106, the routing module 130 may display routing of the vendor 106 to the location B because there is a higher chance of getting more profit from the location B. In the same illustration, after completion of sale in the location B, the routing module 130 may display the routing of the vendor 106 to the location C instead of the location A, which is closer, because there is a higher chance of selling slightly perished goods in the location C.

The routing options may be refined using the machine learning engine 104. In one embodiment, pattern recognition may be used to refine the routing options. For instance, the machine learning engine 104 may identify that the same pattern keeps repeating after a given period of time.

Dynamically determining the routing options in the area map may be based on the recommendations to the vendors 106, the vendor location data 136, the customer location data 138, the inventory of products 140, the travel costs, profit maximization and costs minimization objective, expected waiting periods of the vendors 106, the purchasing history of the potential customers 108, the shelf life of the products and the demand for the products. In an illustration, the routing module 130 may initially display the routing of the vendor 106 to location X instead of the location Y, which is nearer, because there may be lesser waiting period and higher demand in the location X.

After dynamically determining the routing options, managing the notification to the potential customers 108, may be done using the notification management module 132. The notifications may be the vendor location data 136, the products that are available for sale and the prices of the products for each potential customer 108. In one embodiment, the notifications to the potential customers 108 may be sent via one or more beacons 110. In one illustration, when the vendor's mobile phone comes into proximity to the beacon 110 associated with Area 1, then the potential customers 108 in proximity to the beacon of Area 1 may be notified. The mobile phones of the potential customers 108 that are not in proximity to the beacon 110 may get the notification via Bluetooth or pushed from localized system based on GPS feedback about the location of the vendor 106.

Each vendor 106 may be associated with two IDs. The first ID may indicate the source of the products. For instance the vendor 106 coming from Warehouse 1 (Wh1) may have the ID 0234Wh1. The second ID may be used to indicate the particular vendor 106 for that particular day. Customer 108 may also have an ID that indicates the particular potential customer 108. Customer ID may be necessary, for instance to retrieve the past purchasing history. This may be necessary because offered price for each product may be different for different customers 108 based on the past purchasing history.

The notification management involves organizing the notifications to avoid conflicting notifications to the potential customers 108. If there are several notification systems, then repetitive notifications may be avoided by making the notification systems communicate with each other. In one illustration, a customer is in proximity to beacon 1 and beacon 2, where beacon 1 and beacon 2 are both associated with the same vendor 106 and the same area. Beacon 1 may send notification to the vendor 106. Beacon 1 may also inform beacon 2 that the notification has been sent, thus avoiding spamming the potential customers 108 mobile phone with the same message. In another illustration, the beacon 110 may have notified the potential customer 108 of the presence of a vendor 106 in area 1. However, in the same illustration, the vendor 106 may have moved from area 1 to area 2. In this case the potential customer 108 needs to be informed of the change in the vendor location data 136. The vendor location data 136 may be tracked using the GPS and using the vendor location data, the notification management module 132 may inform the customer 108 of the change in location of the vendor 106.

In one embodiment, the processing circuit 102 may be part of a cloud.

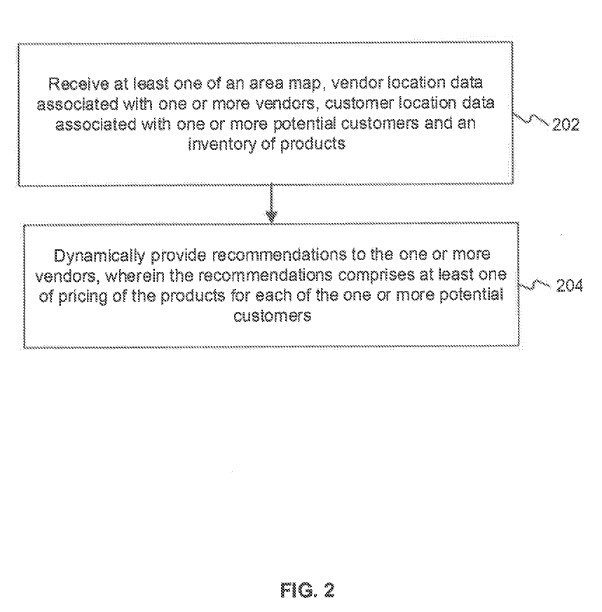

FIG. 2 is a flow diagram illustrating a method of dynamically providing recommendations to one or more vendors 106. With reference to FIG. 2, at least one of an area map, vendor location data 136 associated with one or more vendors 106, customer location data 138 associated with one or more potential customers 108 and an inventory of products 140, may be received at step 202. In one implementation, the vendor location data 136 and the customer location data 138 may be determined using Global Positioning System (GPS). The vendor location data 136 may be present location of the one or more vendors 106. The customer location data 138 may be present location of the one or more potential customers 108. The area map may be built using satellite imagery, data provided by mobile phones of the one or more vendors 106 and data provided by the mobile phones of the one or more potential customers 108. In one embodiment, the area map may comprise vertical divisions of area and horizontal divisions of area. In another embodiment, the area map may further comprise a pictorial view of the expected waiting period of the one or more vendors 106. In one embodiment, the expected waiting period may be determined using number of potential customers 108 in the particular area (the particular area may be the area where the vendor 106 is attempting to make a sale), demand of the potential customers 108 for a product mix and purchasing history of the potential customers 108. In another embodiment, the area map may indicate a pictorial representation of previous sale of products in different time ranges.

After receiving the at least one of an area map, vendor location data 136 associated with one or more vendors 106, customer location data 138 associated with one or more potential customers 108 and an inventory of products 140, recommendations may be dynamically provided to the one or more vendors 106, at step 204. The recommendations may comprise a recommendation for pricing of the products for each potential customer 108. In one embodiment, the recommendations may further comprise, recommended location that may be indicated in the area map, number of vendors 106 assigned to the particular area for the specific time, quantity of the products for the particular area, product mix for the particular area, expected profit margins from the products and expected waiting period of the vendors 106. The recommended location may be the same as the particular area, when the vendor 106 accepts the recommendation of the processing circuit 102. For instance, when the recommended location is location A and the vendor 106 decides to go to location A. The recommended location may be different from the particular area when the vendor 106 rejects the recommendation of the processing circuit 102.

In one embodiment, the recommendations to the vendors 106 may be based on the vendor location data 136, the customer location data 138, the inventory of products 140, the expected waiting period of the vendors 106 in the particular area, the purchasing history of each potential customers 108 in the particular area, shelf life of the products, travel costs, demand for the products in the particular area, and the season.

In one illustration, the pricing of the products may be recommended to the vendors. Initial pricing of the products may be determined from costs for procuring the products, the travel costs, vendor salary, profit margin and customer discount. The travel costs may comprise vehicle costs, vehicle maintenance costs and fuel costs. In one illustration, the vehicle may be a cart. The profit margin may be determined from the costs for procuring the products, demand for the products in the particular area for the particular time and perishable product factor. In one illustration, the perishable product factor may be a time-temperature indicator. In one illustration, the profit margin may be determined using the following equation:

PM=αC+βP_{d}−μ−λD
Where,
C—Cost of the product
P_{d}— Product demand in the particular area
D—Customer discount
μ—Perishable product factor
μ∞1/Dₚ, wherein Dₚ is a representation of the number of days for the product to perish.

In one illustration, an image of the products may be taken and fed to the processing circuit 102. Using Image Processing Techniques, the Dₚ factor may be determined which may enable the processing circuit 102 to recommend a profit margin for the recommended location and the particular time.

After recommending initial pricing, the pricing of the products may be updated based on the vendor location data 136, the customer location data 138, the inventory of products 140, the expected waiting period of the vendors 106 in the particular area, the purchasing history of each potential customers 108 in the particular area, the shelf life of the products, the travel costs, the demand for the products in the particular area, and the season. In one illustration, the pricing may be increased in situations where the vendor location data 136 or customer location data 138 indicates a posh area. In one illustration, the pricing of the products may also be increased if the products availability in the inventory is low. In other words, the price may be increased when the product is a rare item. In another illustration, the pricing of the products may be decreased if the expected waiting period for the vendors 106 is high. In another illustration, the pricing of the products may be decreased if the purchasing history of the potential customers 108 show a reluctance to pay high prices. Pricing of the product may be lesser when the product is closer to the end of its shelf life, in one illustration. If the travel costs are higher, the vendors 106 may demand a higher price, in one illustration. If the demand for a particular product is high, then the vendors 106 may demand a higher price for that particular product, in another illustration. In another illustration, the prices may be higher for the products that are invariably purchased during festive seasons such as Christmas trees during Christmas season. The list of the recommendations is not an exhaustive list. In one illustration, the demand for the products in area 1 may be reduced substantially because the process of sale may have become monotonous in area 1. A recommendation to the vendor 106 in area 1 may be to change the look and feel of the cart, to attract customers 108. The recommendations may be improved using a machine learning engine 104. For instance, if a change in the look and feel of the cart in area 2 did not lead to an increase in demand then a different vendor 106 may be routed to area 2.

In one illustration, the initial pricing of the products may be determined using the following equations:

P=C+Cₘ+S_{y}+PM−D (1)
Where,
P—Initial pricing of the product.
C—Procuring costs
Cₘ—Travel costs per day
S_{y}— Vendor salary per day
PM—Profit margin
D—Customer discount

The initial pricing may be updated based on the equation, P=XC+YCₘ+ZS_{y}+Ω PM, where the X, Y, Z and Ω are factors that are based on the vendor location data 136, the customer location data 138, the inventory of products 140, the expected waiting period of the vendors 106 in the particular area, the purchasing history of each potential customers 108 in the particular area, the shelf life of the products, the travel costs, the demand for the products in the particular area, and the season. These factors may be stored in a database, and these may be used to improve the accuracy of the processing circuit 102. In one illustration, X, Y, Z and Ω factors in Christmas season of 2007 may be found to be similar to the X, Y, Z and Ω factors in Christmas season of 2006 for the same area. Then the X, Y, Z and Ω factors may be saved according to the time interval for the area and it may be reused for the same time interval in the same area for the next year. When the system matures, the linear equation (1) may be evolved to quadratic form, parabolic form or cubic form.

The recommendations to the vendors 106 may also comprise a recommendation of the number of vendors 106 to be assigned to the particular area for the particular time. An illustration for the particular time may be Sunday morning. In one embodiment, the number of vendors 106 that needs to be assigned to the particular area for the particular time may be determined, using the queueing theory. In one illustration, λ may be arrival rate of the potential customers 108 and μ may be service rate of the vendors 106. Traffic intensity in the illustration may be ρ=λ/μ. The length of a system (or the particular area) may be determined using the equation Lₛ=ρ/(1−ρ). From the length of the particular area, the average waiting time of the potential customers 108 in the particular area may be determined using the equation, Wₛ=Lₛ/λ. The number of vendors 106 that can efficiently manage the potential customers 108 in the particular area may be calculated using the Wₛ. For instance, on Sundays, the average waiting period of the potential customers 108 may be 30 minutes when only one vendor 106 with a service rate of 5, is managing the customers 108. 6 more vendors 106 with the same service rate of 5 may be able to handle the demand of the customers 108 better.

The recommendation to the vendors 106 are not enforced upon the vendors 106. For instance, the processing circuit 102 may suggest a pricing of 3$ for a product. The vendor 106 may choose to ask for 5$, instead. In this case, the processing circuit 102 may display to the vendor 106, the loss that the vendor may have to incur if the vendor 106 attempts to sell the product for 5$.

In addition to dynamically providing recommendations to the vendors 106, the processing circuit 102 may also dynamically determine routing options in the area map. The end objective of routing is to minimize costs and maximize profit. The area map may consist of all the recommended locations along with an improvised routing displaying the order in which these recommended locations may be approached, by the vendors 106. In one illustration, location A, location B and location C are the recommended locations. Even though the location A is nearer to the vendor 106, the processing circuit 102 may initially display the routing of the vendor 106 to the location B because there is a higher chance of getting more profit from the location B. In the same illustration, after the completion of sale in the location B, the processing circuit 102 may display the routing of the vendor 106 from the location B to the location C instead of the location A, which is closer, because there is a higher chance of selling slightly perished goods in the location C.

The routing options may be refined by the processing circuit 102, using machine learning techniques. In one embodiment, pattern recognition may be used to refine the routing options. For instance, the processing circuit 102 may identify that the same pattern keeps repeating after a given period of time.

Dynamically determining the routing options in the area map may be based on the recommendations to the vendors 106, the vendor location data 136, the customer location data 138, the inventory of products 140, the travel costs, profit maximization and costs minimization objective, expected waiting periods of the vendors 106, the purchasing history of the potential customers 108, the shelf life of the products and the demand for the products. In an illustration, the processing circuit 102 may initially display the routing of the vendor 106 to location X instead of the location Y, which is nearer, because there may be lesser waiting period and higher demand in the location X.

After dynamically determining the routing options, managing notifications to the potential customers 108 may be done. The notifications may be the vendor location data 136, the products that are available for sale and the prices of the products for each potential customer 108. In one embodiment, the notifications to the potential customers 108 may be sent via one or more beacons 110. In one illustration, when the vendor's mobile phone comes into proximity to the beacon 110 associated with Area 1, then the potential customers 108 in proximity to the beacon of Area 1 may be notified. The mobile phones of the potential customers 108 that are not in proximity with the beacon 110 may get the notification via Bluetooth or pushed from localized system based on GPS feedback about the location of the vendor 106.

Each vendor 106 may be associated with two IDs. The first ID may indicate the source of the products. For instance, the vendor 106 coming from Warehouse 1 (Wh1) may have the ID 0234Wh1. The second ID may be used to indicate the particular vendor 106 for that particular day. Customer 108 may also have an ID that indicates the particular potential customer 108. Customer ID may be necessary, for instance to retrieve the past purchasing history. This may be necessary because offered price for each product may be different for different customers 108 based on the past purchasing history.

The notification management involves organizing the notifications to avoid conflicting notifications to the potential customers 108. If there are several notification systems, then repetitive notifications may be avoided by making the notification systems communicate with each other. In one illustration, a customer 108 is in proximity to beacon 1 and beacon 2, where beacon 1 and beacon 2 are both associated with the same vendor 106 and the same area. Beacon 1 may send notification to the vendor 106. Beacon 1 may also inform beacon 2 that the notification has been sent, thus avoiding spamming the potential customers 108 mobile phone with the same message. The particular customer 108 may be identified using the customer ID. In another illustration, the beacon 110 may have notified the potential customer 108 of the presence of a vendor 106 in area 1. However, in the same illustration, the vendor 106 may have moved from area 1 to area 2. In this case the potential customer 108 needs to be informed of the change in the vendor location data 136. The vendor location data 136 may be tracked using the GPS. Using updated vendor location data 136, the processing circuit 102 may inform the customers 108 of the change in location of the vendor 106.

### Computer System

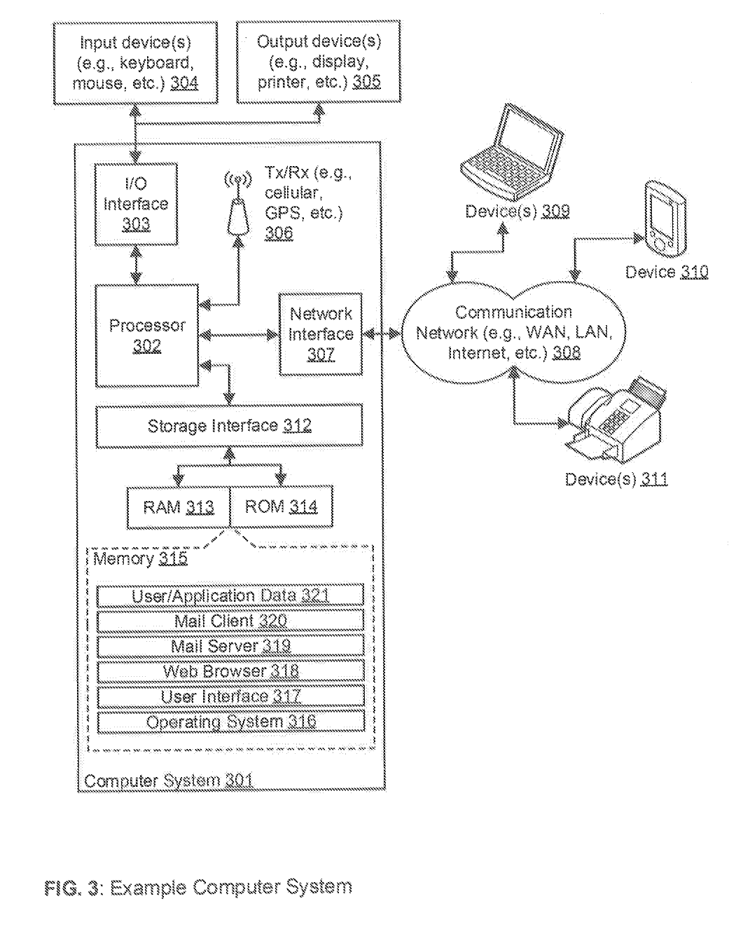

FIG. 3 is a block diagram of an exemplary computer system for implementing embodiments consistent with the present disclosure. Variations of computer system 301 may be used for implementing the processing circuit. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect. Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described application title. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically providing recommendations to one or more vendors, the method comprising:
receiving, by a processing circuit, at least one of an area map, vendor location data associated with the one or more vendors, customer location data associated with one or more potential customers and an inventory of products; and
dynamically providing, by the processing circuit, the recommendations to the one or more vendors, wherein the recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time, wherein the recommendations comprises at least one of recommended pricing of the products for each of the one or more potential customers.

2. The method as claimed in claim 1, further comprising dynamically determining routing options in the area map, based on the recommendations, the vendor location data, the customer location data, the inventory of products and at least one of travel costs, profit maximization and cost minimization objective, expected waiting period of the one or more vendors in the particular area for the particular time, purchasing history of each of the one or more potential customers in the particular area for the particular time, the shelf life of the products, demand for the products in the particular area for the particular time.

3. The method as claimed in claim 1, wherein the area map comprises at least one of vertical divisions of area, horizontal divisions of area, pictorial view of the expected waiting period of each of the one or more vendors, pictorial view of demographics or pictorial view of the products previously sold in different time ranges.

4. The method as claimed in claim 1, wherein the recommendations comprises at least one of recommended locations associated with the area map, number of vendors assigned to the particular area for the particular time, quantity of the products for the particular area, product mix from the inventory of products for the particular area, expected profit margins from the products or expected waiting period of the one or more vendors.

5. The method as claimed in claim 4, wherein the quantity of the products for the particular area is determined by modelling transportation problem.

6. The method as claimed in claim 4, wherein the number of vendors assigned to the particular area for the particular time is determined using queueing theory.

7. The method as claimed in claim 1, further comprising determining the recommended pricing of the products based on costs for procuring the products, travel costs, vendor salary, profit margin and customer discount, wherein the travel costs comprises at least one of vehicle costs, vehicle maintenance costs or fuel costs.

8. The method as claimed in claim 7, wherein the profit margin is based on at least one of the costs for procuring the products, demand for the products in the particular area for the particular time, or perishable product factor.

9. The method as claimed in claim 1, further comprising enhancing the recommendations and the routing options using machine learning.

10. The method as claimed in claim 1, further comprising managing notifications to the one or more potential customers, wherein the notification comprises at least one of vendor location data, products that are available for sale or prices of the products for each of the one or more potential customers.

11. A system for dynamically providing recommendations to one or more vendors, the system comprising:
a processor;
a memory communicatively coupled to the processor, wherein the memory stores the processor-executable instructions, which, on execution, causes the processor to:
receive at least one of an area map, vendor location data associated with the one or more vendors, customer location data associated with one or more potential customers and an inventory of products; and
dynamically provide the recommendations to the one or more vendors, wherein the recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time, wherein the recommendations comprises at least one of recommended pricing of the products for each of the one or more potential customers.

12. The system as claimed in claim 11, wherein the processor is further configured to dynamically determine routing options in the area map, based on the recommendations, the vendor location data, the customer location data, the inventory of products and at least one of travel costs, profit maximization and cost minimization objective, expected waiting period of the one or more vendors in the particular area for the particular time, purchasing history of each of the one or more potential customers in the particular area for the particular time, the shelf life of the products, demand for the products in the particular area for the particular time.

13. The system as claimed in claim 11, wherein the area map comprises at least one of vertical divisions of area, horizontal divisions of area, pictorial view of the expected waiting period of each of the one or more vendors, pictorial view of demographics or pictorial view of the products previously sold in different time ranges.

14. The system as claimed in claim 11, wherein the recommendations comprises at least one of recommended locations associated with the area map, number of vendors assigned to the particular area for the particular time, quantity of the products for the particular area, product mix from the inventory of products for the particular area, expected profit margins from the products or expected waiting period of the one or more vendors.

15. The system as claimed in claim 14, wherein the quantity of the products for the particular area is determined by modelling transportation problem.

16. The system as claimed in claim 14, wherein the number of vendors assigned to the particular area for the particular time is determined using queueing theory.

17. The system as claimed in claim 11, wherein the processor is further configured to determine the recommended pricing of the products based on costs for procuring the products, travel costs, vendor salary, profit margin and customer discount, wherein the travel costs comprises at least one of vehicle costs, vehicle maintenance costs or fuel costs.

18. The system as claimed in claim 17, wherein the profit margin is based on at least one of the costs for procuring the products, demand for the products in the particular area for the particular time, or perishable product factor.

19. The system as claimed in claim 11, wherein the processor is further configured to manage notifications to the one or more potential customers, wherein the notification comprises at least one of vendor location data, products that are available for sale or prices of the products for each of the one or more potential customers.

20. A non-transitory computer readable medium including instruction stored thereon that when processed by at least one processor cause a system to perform operations comprising:
receiving at least one of an area map, vendor location data associated with
the one or more vendors, customer location data associated with one or more potential customers and an inventory of products; and
dynamically providing the recommendations to the one or more vendors,
wherein the recommendations are based on the vendor location data, the customer location data, the inventory of products and at least one of expected waiting period of the one or more vendors in the particular area for the particular time, purchasing history of each of the one or more potential customers in the particular area for the particular time, shelf life of products, travel costs, demand for the products in the particular area for the particular time, or season associated with the particular time, wherein the recommendations comprises at least one of recommended pricing of the products for each of the one or more potential customers.
